(19) United States
(12) Patent Application Publication
(10) Pub. No.: US 2019/0233111 A1
(43) Pub. Date: Aug. 1, 2019

(54) CATCH NETS TOWER FOR UAV DELIVERY

(71) Applicant: Walmart Apollo, LLC, Bentonville, AR (US)

(72) Inventors: Donald R. HIGH, Noel, MO (US); Robert CANTRELL, Herndon, VA (US); Brian MCHALE, Oldham (GB)

(73) Assignee: Walmart Apollo, LLC, Bentonville, AR (US)

(21) Appl. No.: 16/260,752

(22) Filed: Jan. 29, 2019

Related U.S. Application Data
(60) Provisional application No. 62/624,684, filed on Jan. 31, 2018.

(51) Int. Cl. B64D 1/12; A47G 29/14; B64C 39/02

(52) U.S. Cl. CPC B64D 1/12; A47G 29/141; B64C 2201/128; A47G 2029/144; A47G 2029/142; B64C 39/024

(57) ABSTRACT

A catch net for receiving a package from an aerial vehicle. The catch net has a net, the net configured to receive the package from the aerial vehicle. The catch net has a structure configured to support the net. The catch net has a module operably coupled to at least one of the net or the structure. The catch net is configured to move between a first position where the catch net is stored and a second position where the catch net is deployed for receiving a package. The catch net is configured to move between the first position and the second position via a signal sent to the module from at least one of the aerial vehicle or a consumer mobile device.

### CROSS REFERENCE TO RELATED APPLICATIONS

This present Patent Application claims priority benefit from U.S. Provisional Patent Application No. 62/624,684 filed on Jan. 31, 2018, the entire content of which is hereby incorporated herein by reference.

### TECHNICAL FIELD OF THE INVENTION

The present application relates to a delivery tower for receiving a package from an aerial vehicle. More specifically, the present application relates to catch nets for a delivery tower for aerial vehicle package delivery.

### BACKGROUND OF THE INVENTION

Currently, delivery towers have been made for receiving packages from unmanned aerial vehicles (UAVs). UAVs may be programmed for a controlled delivery from a first controlled point (such as a warehouse or store) to a second controlled point, or delivery tower. Existing delivery towers may be sophisticated, expensive, complex, and have a large permanent footprint. Thus, existing delivery towers are not suitable for smaller delivery locations, such as homes and urban areas. Therefore, a need exists for a delivery tower which may be used in a home, convenience store, or other urban area and may reduce the cost and footprint of existing delivery towers. A need further exists for a delivery tower which may have a low profile with a catch net for receiving packages that may create greater value for customers and reduce the drawbacks of having a permanent delivery tower installed in a particular location.

### BRIEF SUMMARY OF THE INVENTION

According to an embodiment a catch net for receiving a package from an aerial vehicle may include a net, the net configured to receive the package from the aerial vehicle; a structure configured to support the net; and a module operably coupled to at least one of the net or the structure. The catch net is configured to move automatically between a first position where the catch net is stored and a second position where the catch net is deployed for receiving a package. The catch net is configured to move between the first position and the second position via a signal sent to the module from at least one of the aerial vehicle or a consumer mobile device.

According to an embodiment a method for aerial delivery of a package to a delivery location may include providing a catch net on a consumer's property; moving the catch net from a first position to a second position, the second position configured to receive the package, based on a first signal communicated from an aerial vehicle or mobile device to the catch net when the aerial vehicle is within a predetermined distance from the catch net; depositing the package from the aerial vehicle onto the catch net; moving the second position to the first position, the first position configured to be stored on the consumer's property, based on a third signal communicated from the aerial vehicle or mobile device to the catch net; and retrieving the package from the catch net.

### BRIEF DESCRIPTION OF DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a schematic of a catch net, according to an embodiment of the present disclosure;

FIG. 2 shows a schematic of a catch net, according to an embodiment of the present disclosure;

FIG. 3 shows a schematic of a catch net, according to an embodiment of the present disclosure;

FIG. 4A shows a schematic of a catch net in a first position, according to an embodiment of the disclosure;

FIG. 4B shows a schematic of a catch net in a second position, according to an embodiment of the present disclosure; and

FIG. 5 shows a block diagram of a delivery system including a catch net, according to an embodiment of the present disclosure.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. A person skilled in the relevant art would recognize that other equivalent parts can be employed and other methods developed without departing from the spirit and scope of the invention. All references cited herein are incorporated by reference as if each had been individually incorporated.

The present disclosure relates to delivering packages to a particular location, such as a home or store (such as a corner store, convenience store, etc.), or other location. The particular location of delivery may include a delivery tower having a catch net, as will be described below. The catch nets may have a basket configuration extending from a structure (such as a building, roof, etc.), a slide configuration, or a horizontal configuration. The catch nets may be movable into a deployed position when a package is to be delivered. The catch nets may be moveable between a retracted position and extended position. The catch nets may have a controller and/or communications module for controlling the deployment, location, and operation of the catch net and for communicating with the aerial vehicle, such as a UAV. The catch nets may allow for packages to be delivered

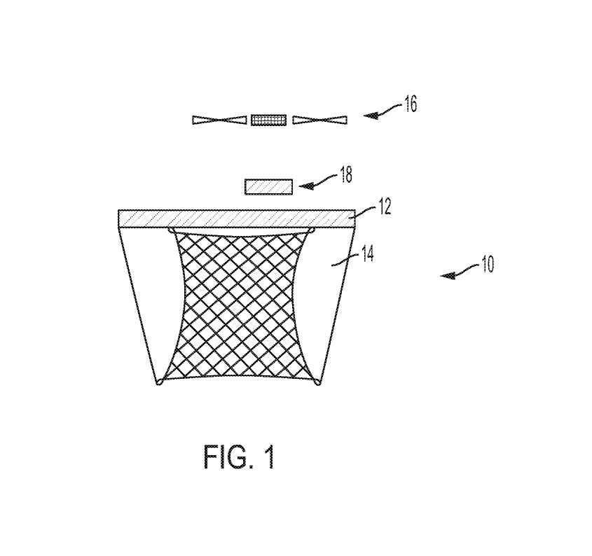

Referring to FIG. 1, a schematic view of a catch net 10 is shown. The catch net 10 may include a frame 12 and a net 14. The net 14 may extend downward from the frame 12, similar to a basketball net or butterfly net. The net 14 may have a closed bottom that may be selectively openable. The frame 12 may be hollow such that a package may deposited therein and may have any shape, square, circular, rectangular, etc. The catch net 10 may be moveable between a stored position (not depicted) and a deployed position (FIG. 1), as will be described in more detail. The catch net 10 may include controllers, sensors, and/or communication devices to control the position, size, and location of the catch net 10 either autonomously or manually. The catch net 10 may be mounted to a permanent structure, such as a building wall, roof, delivery tower, etc. Alternatively, the catch net 10 may be mounted to a temporary or moveable structure, such as a temporary delivery tower, retractable delivery tower, outdoor landscaping or furniture, etc. The catch net 10 may be coupled to an extendable leaf or platform. The extendable leaf or platform may be actuated to extend from the surface (e.g. building wall or roof) from which it is coupled.

With continued reference to FIG. 1, when an aerial vehicle 16, such as a UAV, is scheduled to deliver a package 18 to a consumer, the catch net 10 may be moved into a delivery location and moved into the deployed position of FIG. 1. For example, the catch net 10 may be coupled or mounted to a building wall or roof. In a stored position, the catch net 10 may be folded against the surface. When delivery of a package 18 is expected, the catch net 10 may be unfolded into a position capable of receiving the package 18. In an exemplary embodiment, this operation may be similar to the operation of retracting and extending a basketball net in a sporting arena and may include the same or similar components. The catch net 10 may be coupled to a mobile unit which may move from a stored location (in a shed, garage, etc.) to an open area free from obstacles. The catch net 10 may be coupled to a tower that is raised and lowered during operation. For example, when not in use the tower may be in a lowered position. When a package 18 is to be delivered, the tower may be raised (e.g. with telescoping members) such that the catch net 10 is sufficiently high to receive the package safely from the aerial vehicle 16. The tower may again be lowered after receipt of the package 18 such that the consumer may remove the package from the catch net 10. Any of the previously described movements of the catch net 10 may be performed manually by the consumer or autonomously as instructed by the aerial vehicle and/or consumer's mobile device.

After delivery of the package 18 into the catch net 10, the consumer may retrieve the package 18 from the catch net 10. The consumer may reach into the opening of the frame 12 to retrieve the package. The catch net 10 may be lowered to an appropriate height (e.g. to around the height of the consumer or shorter than the height of the consumer) for retrieval of the package 18. Alternatively, the net 14 may have a selectively openable panel or door on the bottom to allow for retrieval of the package 18 from a bottom of the catch net 10. Such a lower door or panel will allow for the catch net to have a sufficiently high upper opening so that the aerial vehicle 16 may avoid obstacles, but still have an access point for the consumer that does not require a ladder, step stool, or other height elevation to reach. After retrieval of the package 18, the catch net 10 may be moved to its stored position and/or to a storage location.

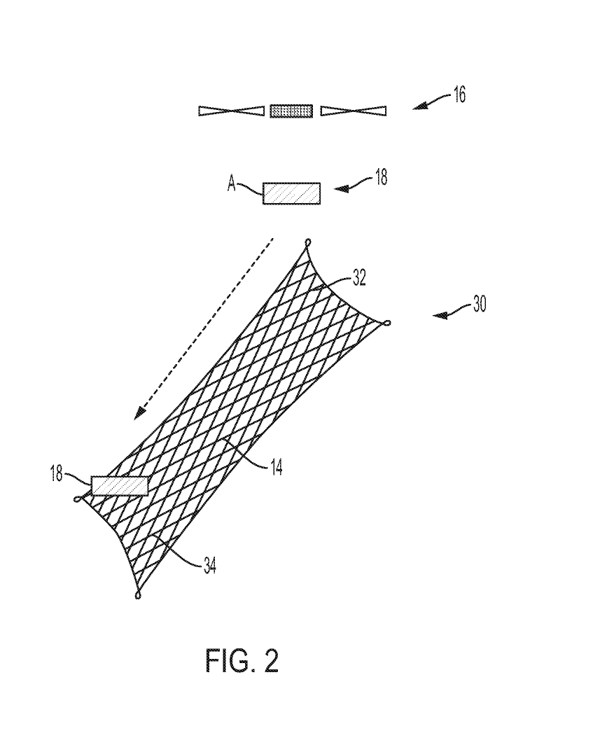

With reference to FIG. 2, a catch net 30 is shown. The catch net 30 may be the same or similar to the catch net 10 and may operate in the same or similar manner as described with respect to FIG. 1. The catch net 30 may take the form of a slide. That is, an upper portion 32 of the catch net 30 may be coupled or mounted to a first position on a building, tower, or roof and a lower portion 34 of the catch net 30 may be coupled or mounted to a second position lower than the first position, such as lower on the building tower, or roof, or on a ground surface.

The catch net 30 may be moveable between a stored position (not depicted) and a deployed position (FIG. 2), as will be described in more detail. The catch net 30 may include controllers, sensors, and/or communication devices to control the position, size, and location of the catch net 30 either autonomously or manually. The catch net 30 may be mounted to a permanent structure, such as a building wall, roof, delivery tower, etc. Alternatively, the catch net 30 may be mounted to a temporary or moveable structure, such as a temporary delivery tower, retractable delivery tower, outdoor landscaping or furniture, etc. The catch net 30 may be coupled to an extendable leaf or platform. The extendable leaf or platform may be actuated to extend from the surface (e.g. building wall or roof) from which it is coupled to deploy the catch net 30.

With continued reference to FIG. 2, when an aerial vehicle 16, such as a UAV, is scheduled to deliver a package 18 to a consumer, the catch net 30 may be moved into a delivery location and moved into the deployed position of FIG. 2. For example, the catch net 30 may be coupled or mounted to a building wall or roof. In a stored position, the catch net 30 may be folded or rolled against the surface. When delivery of a package 18 is expected, the net 14 of the catch net 30 may be unfolded or unrolled into a slide position capable of receiving the package 18, such as the position depicted in FIG. 2. It may be appreciated that in this case, the upper portion 32 of the catch net 30 may be permanently fixed or coupled to a surface and the lower portion 34 may be releasably coupled to the surface. Thus, the lower portion 34 may be moved from a rolled or folded position into a secured, deployed position for package delivery. Alternatively, both the upper portion 32 and the lower portion 34 may be formed with releasable couplings such that the catch net 30 may be folded or rolled and stored in a basement, garage, closet, etc. When it is desired to be deployed, the consumer and/or aerial vehicle may unroll or unfold (either manually or autonomously) the catch net 30 and secure the upper portion 32 and lower portion 34 to the appropriate locations on a structure.

The catch net 30 may be coupled to a mobile unit which may move from a stored location (in a shed, garage, etc.) to an open area free from obstacles. The catch net 30 may be coupled to a tower that is raised and lowered during operation. For example, when not in use the tower may be in a lowered position with the catch net 30 rolled or folded. When a package 18 is to be delivered, the tower may be raised (e.g. with telescoping members) such that the upper portion 32 of the catch net 30 is sufficiently high to receive the package safely from the aerial vehicle 16. The tower may again be lowered after receipt of the package 18 and moved for storage. Any of the previously described movements of the catch net 30 may be performed manually by the consumer or autonomously as instructed by the aerial vehicle and/or consumer's mobile device.

The aerial vehicle 16 may deposit (by dropping via free-fall, parachute drop, cable drop, net drop, etc.) the package 18 near the upper portion 32 of the catch net 30. The package 18 may slide down the catch net 30 to the lower portion 34 to allow retrieval by the consumer. The sliding of the package 18 may be facilitated by the angle of the catch net 30. Accordingly, the angle of the catch net 30 may be selected based on the size and/or weight of the package and/or the height from which the aerial vehicle will drop the package 18.

After delivery of the package 18 into the catch net 30, the consumer may retrieve the package 18 from the catch net 30 near the lower portion 34 of the catch net 30. After retrieval of the package 18, the catch net 30 may be moved and/or rolled or folded to its stored position and/or to a storage location.

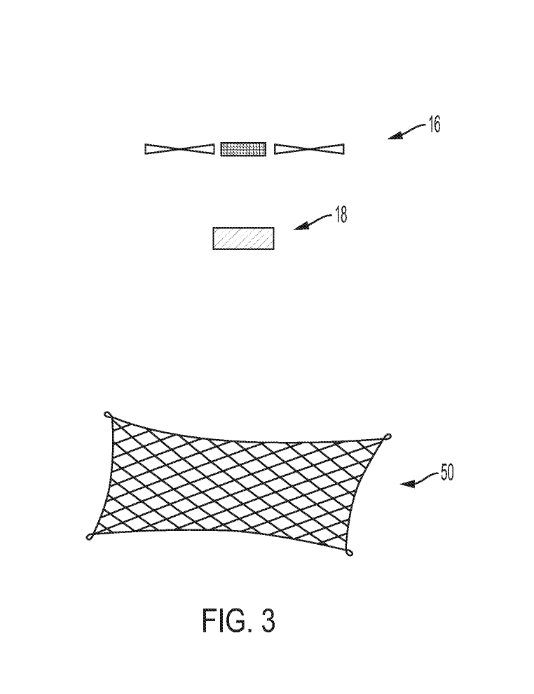

Referring now to FIG. 3, a catch net 50 is shown. The catch net 50 may be the same or similar to the catch nets 10, 30 and may operate in the same or similar manner as described with respect to FIGS. 1 and 2. The catch net 50 may take the form of a horizontal net. That is, the four (or more or less) corners of the catch net 50 may be secured to supports to present a generally horizontal surface for package delivery. For example, the catch net 50 may operate similar to a trampoline. The catch net 50 may be stretched so that it is taut or has a little give in the middle based on the dimension, size, and weight of the package 18 to be delivered. The amount the package is cushioned (or allowed to bounce) by the catch net 50 may be selected and altered based on the aforementioned factors.

The catch net 50 may be moveable between a stored position (not depicted) and a deployed position (FIG. 3), as will be described in more detail. The catch net 50 may include controllers, sensors, and communication devices to control the position, size, and location of the catch net 50 either autonomously or manually. The catch net 50 may be mounted to a permanent structure, such as a building wall, roof, delivery tower, etc. Alternatively, the catch net 50 may be mounted to a temporary or moveable structure, such as a temporary delivery tower, retractable delivery tower, outdoor landscaping or furniture, etc. The catch net 50 may be coupled to an extendable leaf or platform. The extendable leaf or platform may be actuated to extend from the surface (e.g. building wall or roof) from which it is coupled to deploy the catch net 50.

With continued reference to FIG. 3, when an aerial vehicle 16, such as a UAV, is scheduled to deliver a package 18 to a consumer, the catch net 50 may be moved into a delivery location and moved into the deployed position of FIG. 3. For example, the catch net 50 may be coupled or mounted to a building wall or roof. In a stored position, the catch net 50 may be folded or rolled against the surface. When delivery of a package 18 is expected, the catch net 50 may be unfolded or unrolled into a generally horizontal position capable of receiving the package 18, such as the position depicted in FIG. 3. It may be appreciated that in this case, the corners or sides of the catch net 50 may be releasably coupled or fixed to the surface. Accordingly, the corners or sides of the catch net 50 may be formed with releasable couplings such that the catch net 50 may be folded or rolled and stored in a basement, garage, closet, etc. When it is desired to be deployed, the consumer and/or aerial vehicle may unroll or unfold (either manually or autonomously) the catch net 30 and secure the upper portion 32 and lower portion 34 to the appropriate locations on a structure.

The catch net 50 may be coupled to a mobile unit which may move from a stored location (in a shed, garage, etc.) to an open area free from obstacles. The catch net 50 may be coupled to one or more towers that are raised and lowered during operation. For example, when not in use the towers may be in a lowered position with the catch net 50 rolled or folded. When a package 18 is to be delivered, the towers may be raised (e.g. with telescoping members) such that the catch net 50 is sufficiently high and substantially horizontal to receive the package safely from the aerial vehicle 16. The tower may again be lowered after receipt of the package 18 and moved for storage. Any of the previously described movements of the catch net 50 may be performed manually by the consumer or autonomously as instructed by the aerial vehicle and/or consumer's mobile device.

As may be appreciated, the aerial vehicle 16 may deposit (by dropping via free-fall, parachute drop, cable drop, net drop, etc.) the package 18 on the catch net 50. The package 18 may be allowed to bounce or the catch net 50 may give slightly to safely receive the package 18. After delivery of the package 18 into the catch net 50, the consumer may retrieve the package 18 from the catch net 50. After retrieval of the package 18, the catch net 50 may be moved and/or rolled or folded to its stored position and/or to a storage location.

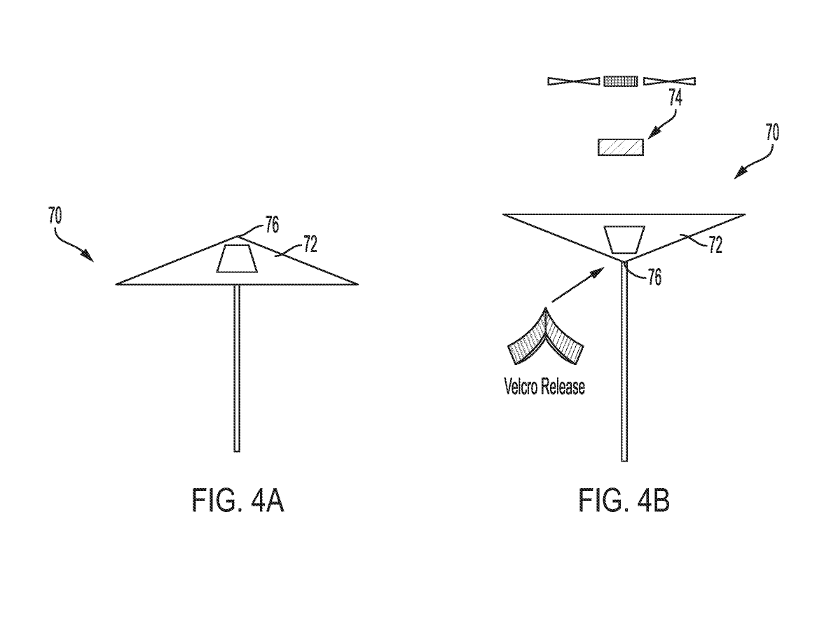

Referring to FIGS. 4A and 4B, a catch net 70 is shown. The catch net 70 may have a canopy 72 that serves as a canopy, patio parasol, or umbrella over an outdoor space or table, as depicted in FIG. 4A. When a package 74 is to be delivered, the canopy 72 may be inverted (FIG. 4B) to catch the package. The package 74 may slide down the curved surface and rest at an apex 76 of the canopy 72. The apex 76 may have a selectively openable hatch that is secured with Velcro, a zipper, fastener, etc. Thus, the selectively openable hatch may be opened to retrieve the package 74. Alternatively, the apex 76 may have a pouch coupled thereto. The package 74 may be received in the pouch and retrieved by the consumer.

Although the previously described catch nets are disclosed as being used to catch or capture packages delivered by an aerial vehicle, it may be appreciated that the catch nets may be used to capture the aerial vehicle. That is, the aerial vehicle may land in the catch net with the package. After landing/capture of the aerial vehicle, the net may be instructed to move into a flat and/or taut position exposing the aerial vehicle and package. The consumer may retrieve the package from the aerial vehicle and signal to the aerial vehicle that the area is clear for relaunch. With the catch net substantially taut, the aerial vehicle may have a flat surface for re-launch. Alternatively, the catch nets may be used solely as a means to capture and re-launch aerial vehicles, regardless of whether the aerial vehicle carries a package. The aerial vehicle may communicate directly with the catch net to indicate impeding landing and takeoff. The catch net may respond to instructions from the aerial vehicle to deploy itself and to extend the four corners of the catch net to allow for a flat surface for re-launch.

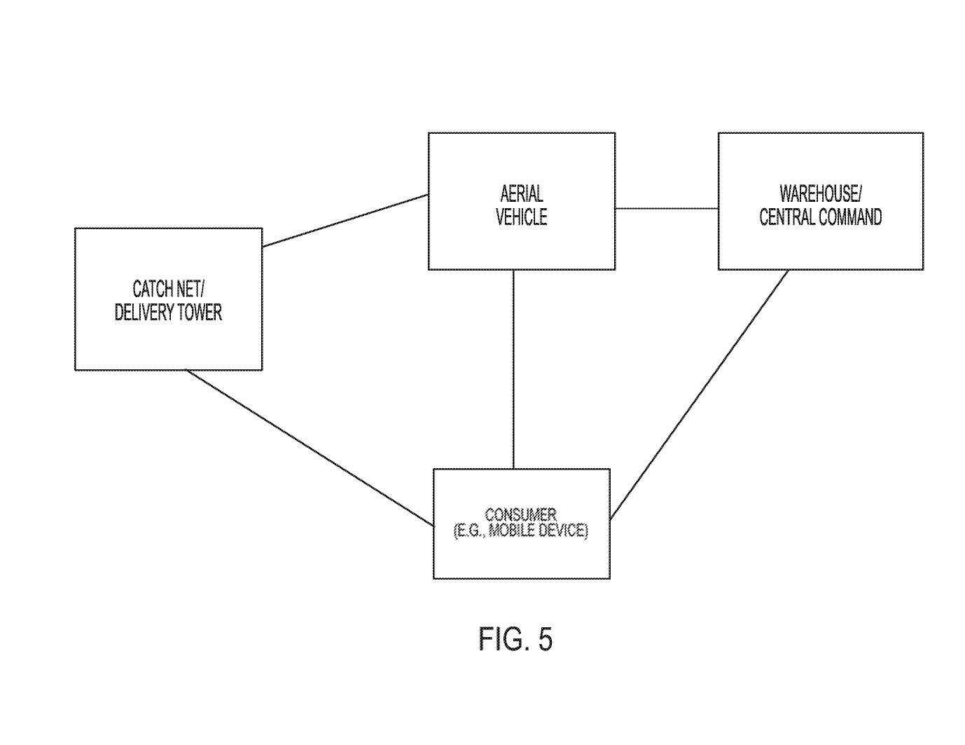

Referring to FIG. 5, a block diagram of a delivery system including one or more of the catch nets of the present disclosure is depicted. The catch nets and/or associated towers may communicate with the aerial vehicle to receive information on package delivery, receive instructions on deployment, receive instructions of storage, and send confirmation of package receipt. The catch nets and/or associated towers may further communicate with the consumer (e.g., to a consumer's mobile device) to receive information on package delivery, receive instructions on deployment, receive instructions of storage, and send confirmation of package receipt. The aerial vehicle may communicate with the consumer's mobile device to send or receive information on package delivery, send or receive instructions on deployment, send or receive instructions of storage, and send or receive confirmation of package receipt. The aerial vehicle and/or the mobile device may communicate with the warehouse to send or receive information on package delivery, and send or receive confirmation of package receipt.

Modules

Any of the catch nets 10, 30, 50 may be provided with controller modules, communications modules, sensor modules, battery modules, lighting modules, movement modules, or other modules.

The controller module may include a controller for controlling the position (such as a height position, deployed position, stored position, retracted position, extended position, folded position, or unfolded position, etc.), a location (such as a stored or open space), etc. The controller module may be electronic buttons or mechanical buttons which allow for folding, unfolding, storing, and/or deploying the catch nets 10, 30, 50.

The communications module may allow the catch nets 10, 30, 50 to communicate with the aerial vehicle and/or a mobile application (“app”) on a consumer's mobile device. The communications device may allow for sending and/or receiving signals to the aerial vehicle. The communications device may send and/or receive signals with a mobile device, such as a consumer's mobile phone or mobile tablet. The aerial vehicle may use its on-board sensors, such as imaging devices and cameras, to locate the net or to verify the location received. The aerial vehicle may use image capabilities (including optical or other image sensors) to locate the catch net or verify the coordinates sent from the catch net and/or mobile device. The image capabilities may also verify delivery of the package.

The sensor module may include sensors, such as pressure sensors or optical sensors. The sensors may communicate with the aerial vehicle and/or mobile device to ensure the catch nets 10, 30, 50 are aligned properly with the package 18 and/or aerial vehicle for delivery. The sensors may sense a weight in the catch nets 10, 30, 50 has increased and send a signal to the consumer's mobile device that the package 18 has been delivered.

The battery module may provide power to the controller module, communications module, and/or any mechanical and electrical components employed to move and deploy the catch nets 10, 30, 50. The battery module may be rechargeable. The battery module may be solar powered. The battery module may be plugged into house current or a designated recharging station to recharge the catch nets 10, 30, 50 and associated components.

The lighting module may include light emitting diodes capable of producing any color. The lighting module may be used to signal to a consumer and/or to the catch nets 10, 30, 50 that delivery of a package is imminent or has been completed.

The movement module may include wheels and/or motors. The movement module may allow for the catch net and/or the delivery tower on which it may be coupled to move to different positions in a consumer's yard or property. For example, it may allow the catch nets 10, 30, 50 to move between a garage, shed, or covered location into an open area, such as open yard. The support structure or delivery tower coupled to catch nets 10, 30, 50 may be actuated to drive into a clear opening with the movement module via a signal from the aerial vehicle, a consumer's mobile device, and/or manually via control buttons located on the catch nets 10, 30, 50. By allowing the catch nets 10, 30, 50 to maneuver and/or drive into a clear opening, one may be sure there are no obstacles, such as roofs, pergolas, trees, covered patios, etc. which obstruct the delivery of the package 18 from the aerial vehicle 16 to the catch nets 10, 30, 50.

Security

The catch nets 10, 30, 50 may include a locking device which may be locked automatically after delivery of package 18. The catch nets 10, 30, 50 may be made of a material which may not be cut by scissors or knives, etc. The locking device and catch net may thus secure the package 18 until retrieval by the consumer. In this manner, an aerial vehicle 16 may communicate solely with the catch nets 10, 30, 50 to deliver the package 18 in the absence of the consumer. The package 18 may be held safe in the catch net 10, 30, 50 until the package 18 may be retrieved by the consumer, thus preventing theft. The locking device may be fitted with a GPS tracker and/or communication device for package security. The catch nets 10, 30, 50 may also include a security camera to monitor the area around the catch net 10, 30, 50.

Delivery Method

The catch nets 10, 30, 50 described herein may be appreciated to operate as follows. The catch nets 10, 30, 50 may be in the stored position. A consumer may place an order for a product in the conventional manner, such as by telephone, mobile device, or computer, etc. The product may be packaged and scheduled for delivery to the consumer. The package 18 may be delivered to the consumer with an aerial vehicle 16, such as a UAV. When the aerial vehicle 16 is near the delivery location, for example, within a about a mile of the delivery location, the aerial vehicle may communicate with the catch net 10, 30, 50 and/or the consumer, as previously described. The aerial vehicle 16 may send a signal to the catch net 10, 30, 50 and/or consumer with instructions to move the catch net 10, 30, 50 from the stored position to the deployed position.

Once the catch net 10, 30, 50 has been deployed to the selected position (selected based on certain parameters, such as size and weight of the package), the aerial vehicle may deliver the package 18 into the net 14. Delivery of the package 18 into the net 14 may be performed in a conventional manner, such as a drop, parachute drop, cable drop, net drop, and other manners for aerial package delivery.

The aerial vehicle 16 may then communicate with the catch net 10, 30, 50 and/or mobile device to indicate the package 18 has been deposited in the net 14. The aerial vehicle 16 may send a signal to the catch net 10, 30, 50 instructing the catch net 10, 30, 50 to retract or lower to a height that is easy to reach by the consumer. The consumer may then retrieve the package from the catch net 10, 30, 50.

Alternatively, the consumer may receive a notification of impending aerial package delivery. The notification may be a visual alert, such as a flashing of lights on the aerial vehicle or may be an e-mail notification, text notification, or mobile phone alert. When the notification is received by the consumer, the consumer may use a manual control or may communicate with the catch net 10, 30, 50 to place the catch net 10, 30, 50 in the deployed position. Notification of the receipt and/or completed delivery of the package may be an e-mail notification, text messaging notification, mobile application alert, and/or mobile phone alert.

The catch nets 10, 30, 50 may include a landing pad identification and/or order identification in a QR code or other machine readable form. Accordingly, the consumer may print the landing pad or order identification and place the same in a clear pouch prior to receiving the package. The aerial vehicle may have sensors or cameras which may read the code ensuring delivery of the proper package to the proper delivery tower.

Alternatively, the catch nets 10, 30, 50 may be provided with an aerial vehicle. The aerial vehicle may operate from the catch net. The aerial vehicle may be launched by the consumer to retrieve a package or product from a vendor. Accordingly, the vendor only need supply the product packaged in a standard box and the consumer supplies the aerial vehicle for retrieval of the package. The vendor may provide the package on a separate delivery tower located at the vendor location such that the aerial vehicle may retrieve and deliver the package autonomously.

As may be appreciated from the foregoing disclosure, the catch nets may provide temporary and/or low profile, discrete delivery locations for aerial vehicle package delivery. The catch nets may be deployed when need to receive a package and stored when not in use. Accordingly, the catch nets provide a user friendly, simple system and method for receiving packages at a home location, convenience store, or other urban area.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

1. A catch net for receiving a package from an aerial vehicle, the catch net comprising:
a net, the net configured to receive the package from the aerial vehicle;
a structure configured to support the net; and
a module operably coupled to at least one of the net or the structure,
wherein the catch net is configured to move between a first position where the catch net is stored and a second position where the catch net is deployed for receiving a package, and
wherein the catch net is configured to move automatically between the first position and the second position via a signal sent to the module from at least one of the aerial vehicle or a consumer mobile device.

2. The catch net of claim 1, further comprising a frame coupled to the net, the net configured to extend downward from the frame in the second position.

3. The catch net of claim 2, wherein the net and frame are configured to move between a retracted position and an extended position.

4. The catch net of claim 3, wherein the frame has an opening configured to receive the package and the net comprises a selectively openable bottom portion configured to allow access to the inside of the net.

5. The catch net of claim 1, wherein, in the second position, the net is coupled to the structure with an upper portion that is at a higher point than a lower portion.

6. The catch net of claim 1, wherein the net is a slide.

7. The catch net of claim 1, wherein the net is coupled to the structure such that the net is substantially horizontal as compared to a ground surface.

8. The catch net of claim 1, wherein the structure is one of a building wall, a building roof, a delivery tower, or a patio umbrella.

9. A method for aerial delivery of a package to a delivery location, the method comprising:
providing a catch net on a consumer's property;
moving the catch net from a first position to a second position, the second position configured to receive the package, based on a first signal communicated from an aerial vehicle or mobile device to the catch net when the aerial vehicle is within a predetermined distance from the catch net;
depositing the package from the aerial vehicle onto the catch net;
moving the second position to the first position, the first position configured to be stored on the consumer's property, based on a third signal communicated from the aerial vehicle or mobile device to the catch net; and
retrieving the package from the catch net.

10. The method of claim 9, wherein the catch net further comprises a net and a frame.

11. The method of claim 10, wherein moving the catch net from the first position to the second position further comprises moving the net and frame between a retracted position and an extended position.

12. The method of claim 9, wherein in the second position, the catch net is coupled to a structure with an upper portion that is at a higher point than a lower portion.

13. The method of claim 9, wherein the catch net is coupled to a structure such that the catch net is substantially horizontal as compared to a ground surface.

14. The method of claim 9, wherein depositing the package further comprises lowering the package from the aerial vehicle on a rope, on a cable, with a parachute, or with a dropping device.
